(19) United States
(12) Patent Application Publication
(10) Pub. No.: US 2018/0330713 A1
(43) Pub. Date: Nov. 15, 2018

(54) Text-to-Speech Synthesis with Dynamically-Created Virtual Voices

(71) Applicant: International Business Machines Corporation, Armonk, NY (US)

(72) Inventors: RON HOORY, Ramat Yishay (IL); MARIA E. SMITH, Davie, FL (US); ALEXANDER SORIN, Haifa (IL)

(21) Appl. No.: 15/594,606

(22) Filed: May 14, 2017

(51) Int. Cl. G10L 13/10; G10L 13/033; G10L 13/047

(52) U.S. Cl. CPC G10L 13/10; G10L 13/047; G10L 13/033

(57) ABSTRACT

Text-to-speech synthesis performed by deriving from a voice dataset a sequence of speech frames corresponding to a text, wherein any of the speech frames is represented in the voice dataset by a parameterized vocal tract component, glottal pulse parameters, and an aspiration noise level, transforming the speech frames in the sequence by applying a voice transformation to any of the parameterized vocal tract component, glottal pulse parameters, and aspiration noise level representing the speech frames, wherein the voice transformation is applied in accordance with a virtual voice specification that includes at least one voice control parameter indicating a value for at least one of timbre, glottal tension and breathiness, and producing a digital audio signal of synthesized speech from the transformed sequence of speech frames.

### BACKGROUND

Text-to-speech (TTS) synthesis is used in computer software and hardware products to convert normal language text into audible speech. In TTS, audio speech samples of a human speaker are prerecorded, processed, and stored in a database as discrete audio segments and supporting data which are later used to form the words and sentences of an input text. A TTS solution provider typically offers a limited selection of prepared voices corresponding to actual human speakers. Those that employ TTS in their products may wish to employ multiple voices, such as when producing a multi-speaker conversation. However, as building a voice for TTS is a costly and time-consuming process, providing multiple TTS voices on demand presents a great challenge to TTS solution providers.

### SUMMARY

In one aspect of the invention a method is provided for text-to-speech synthesis including deriving from a voice dataset a sequence of speech frames corresponding to a text, wherein any of the speech frames is represented in the voice dataset by a parameterized vocal tract component, glottal pulse parameters, and an aspiration noise level, transforming the speech frames in the sequence by applying a voice transformation to any of the parameterized vocal tract component, glottal pulse parameters, and aspiration noise level representing the speech frames, wherein the voice transformation is applied in accordance with a virtual voice specification that includes at least one voice control parameter indicating a value for at least one of timbre, glottal tension and breathiness, and producing a digital audio signal of synthesized speech from the transformed sequence of speech frames.

In other aspects of the invention systems and computer program products embodying the invention are provided.

### BRIEF DESCRIPTION OF THE DRAWINGS

Aspects of the invention will be understood and appreciated more fully from the following detailed description taken in conjunction with the appended drawings in which:

FIG. 1 is a simplified block diagram illustration of a system for preparing a text-to-speech voice dataset, constructed and operative in accordance with an embodiment of the invention;

FIG. 2 is a simplified graphical representation of an exemplary glottal pulse derivative;

FIG. 3 is a simplified block diagram illustration of an exemplary implementation of a glottal encoder, constructed and operative in accordance with an embodiment of the invention;

FIG. 4 is a simplified block diagram illustration of a system for text-to-speech synthesis, constructed and operative in accordance with an embodiment of the invention;

FIGS. 5A and 5B are simplified graphical representations of exemplary polar glottal pulses of different glottal tensions;

FIGS. 6A-6C are simplified graphical representations respectively of an exemplary original glottal pulse derivative, its modification corresponding to a lower glottal tension, and its modification corresponding to a higher glottal tension;

FIG. 7 is a simplified block diagram illustration of an end-to-end system for text-to-speech synthesis with dynamically-created virtual voices, constructed and operative in accordance with an embodiment of the invention; and

FIG. 8 is a simplified block diagram illustration of an exemplary hardware implementation of a computing system, constructed and operative in accordance with an embodiment of the invention.

### DETAILED DESCRIPTION

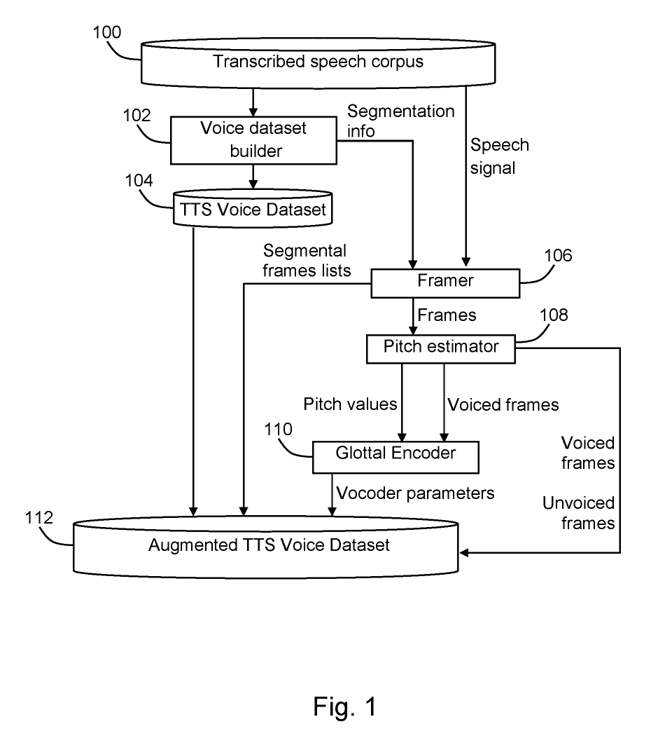

Reference is now made to FIG. 1, which is a simplified block diagram illustration of a system for preparing a text-to-speech voice dataset, constructed and operative in accordance with an embodiment of the invention. In the system of FIG. 1, a transcribed speech corpus 100 includes digital speech signals produced in accordance with conventional techniques from audio recordings of a human speaker along with text transcripts of the audio recordings. A voice dataset builder 102 is configured to create a unit selection text-to-speech (TTS) voice dataset 104 from transcribed speech corpus 100 using a conventional voice building process, such as is described in “The IBM expressive Text-to-Speech synthesis system for American English” (J. Pitrelli, et al., IEEE Transactions on Audio, Speech and Language Processing, vol. 14, no. 4, pp. 1099-1108, 2006) and “Using Deep Bidirectional Recurrent Neural Networks for Prosodic-Target Prediction in a Unit-Selection Text-to-Speech System” (R. Fernandez, et al., Interspeech 2015). As a part of the voice dataset building process, voice dataset builder 102 preferably divides each speech signal into one or more audio speech segments (henceforth referred to simply as “segments”), where each segment represents unique phonetic content, typically at a sub-phone level representing a part of a phoneme. The segments are preferably clustered according to their acoustic properties and phonetic context and labeled by their respective clusters identities. TTS voice dataset 104 is thus preferably constructed to include a segment inventory and all supplementary data required for conventional TTS synthesis, all of which information is stored in TTS voice dataset 104 in association with a unique voice dataset identifier.

Each speech signal from transcribed speech corpus 100 is provided to a framer 106 together with segmentation information generated for the speech signal by voice dataset builder 102, where the segmentation information indicates the segments associated with the speech signal and their boundary time offsets associated with each segment. Framer 106 is configured to divide the speech signal into overlapping frames, such as where frame duration and frame shift are set to 30 ms and 5 ms respectively. Framer 106 assigns a unique identifier to each frame and associates each frame with the segment that has the greatest time overlap with that frame. Framer 106 creates for each segment a segmental frames list which lists all the frames associated with that segment in their natural order. Framer 106 stores the segmental frames lists in augmented TTS voice dataset 112 in association with the aforementioned unique voice dataset identifier.

The sequence of frames produced by framer 106 for each speech signal is provided to a pitch estimator 108 which is configured to classify each frame as either voiced or unvoiced and determine, in accordance with any pitch estimation algorithm, a pitch frequency F0 for each voiced frame, all of which information is stored in augmented TTS voice dataset 112 in association with the aforementioned unique voice dataset identifier. Unvoiced frames are marked as unvoiced, for example, by setting F0=0.

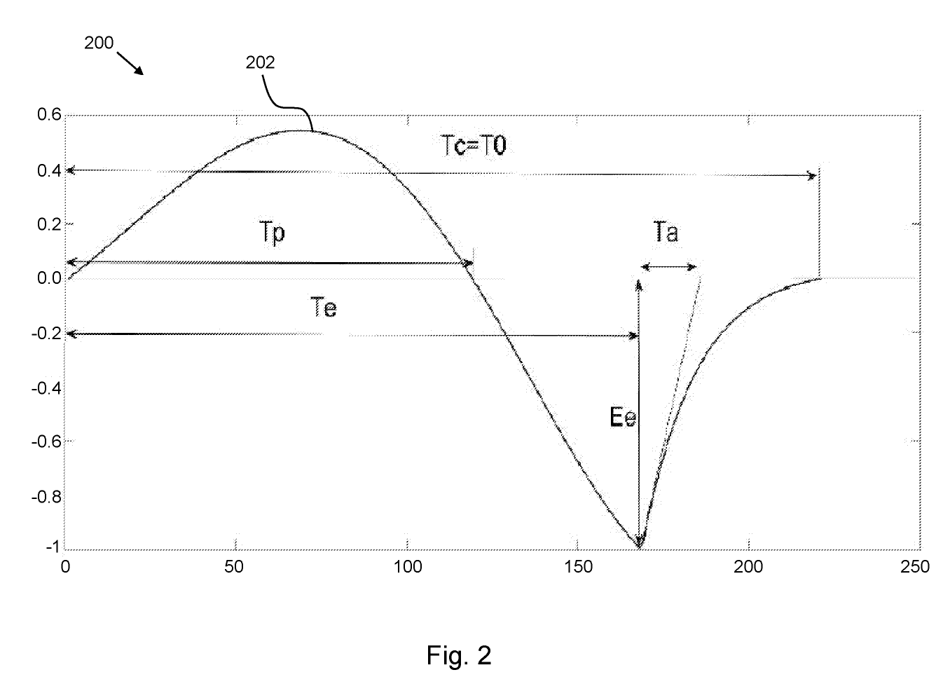

Each voiced frame is provided to a glottal encoder 110 which is configured in accordance with conventional techniques to represent each voiced frame as a parameterized vocal tract component, glottal pulse parameters, and an aspiration noise level. The glottal pulse parameters are preferably derived from gain Ee and time instants Tp, Te, Ta and Tc=1/F0 expressing the general properties of glottal flow, such as is shown in FIG. 2, which is a simplified graphical representation of an exemplary glottal pulse derivative, where Tp denotes rise time, Te denotes the start of the return phase, Ta denotes the return phase duration, T0 denotes the pulse duration (pitch period), and Ee denotes gain. Glottal encoder 110 may employ various parametric representations of the vocal tract component, such as Mel Frequency Cepstral Coefficients, Generalized Cepstral Coefficients, Perceptual Linear Prediction Cepstrum, or Line Spectral Frequencies (LSF) such as are described in “Line spectrum representation of linear predictive coefficients” (F. Itakura, Journal of the Acoustical Society of America, vol. 57, suppl., no. 1, p. S35, 1975). Glottal encoder 110 may employ various glottal pulse models, such as the Liljencrants-Fant (LF) model as described in “A four-parameter model of glottal flow” (G. Fant, et al., STL-QPSR, vol. 4, no. 1985, pp. 1-13, 1985), the Rosenberg model, or the Veldhius model. The vocal tract parameters, glottal pulse parameters, and the aspiration noise level associated with a voiced frame are referred to collectively as vocoder parameters, which are stored in augmented TTS voice dataset 112 in association with the aforementioned unique voice dataset identifier.

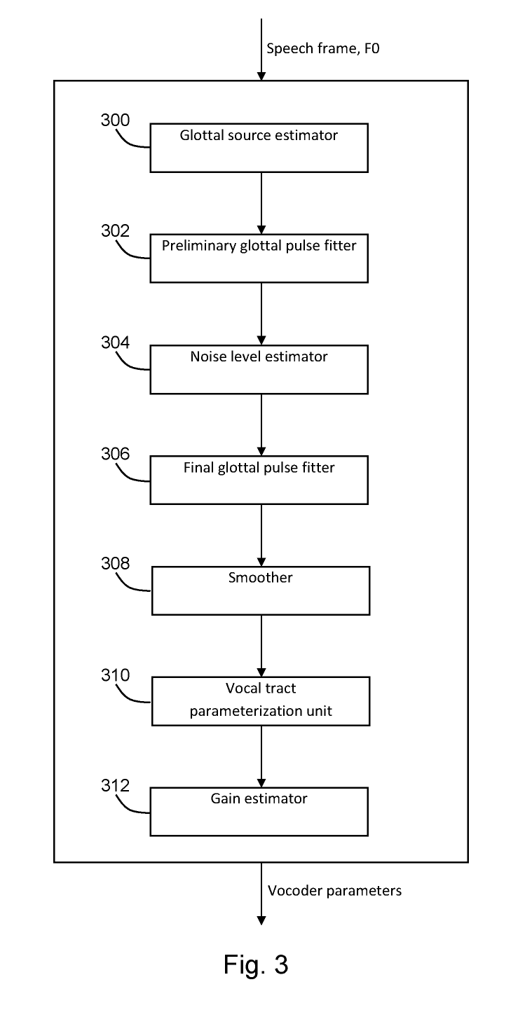

Reference is now made to FIG. 3, which is a simplified block diagram illustration of an exemplary implementation of a glottal encoder, constructed and operative in accordance with an embodiment of the invention, in which a glottal pulse derivative is parameterized using the Liljencrants-Fant (LF) model shown in FIG. 2, where the glottal pulse derivative is represented by the time instant parameters Tp, Te, Ta, duration Tc=T0=1/F0, which is equal to the pitch period, and gain Ee. In the system of FIG. 3, which may be used to implement glottal encoder 110 of FIG. 1, a sequence of consecutive voiced frames and their respective pitch frequency values is processed as follows. The waveform of each voiced frame is provided to a glottal source estimator 300 which estimates a raw glottal source signal h(t), such as by using the Iterative Adaptive Inverse Filtering method described in “Glottal wave analysis with pitch synchronous iterative adaptive inverse filtering” (P. Alku, Speech Communication, vol. 11, pp. 109-118, 1992).

The raw glottal source signal h(t) and the pitch frequency F0 are provided to a preliminary glottal pulse fitter 302 which is configured to fit a preliminary glottal pulse of length T0=1/F0 to the raw glottal source signal h(t) using a simplified, single parameter reduction of the LF pulse shape known as Rd glottal pulse parameterization as described in “The LF-model revisited, transformations and frequency domain analysis” (G. Fant, STL-QPSR Journal, vol. 36, no. 2-3, pp. 119-156, 1995). This is done by performing a joint estimation of the Rd parameter and the optimal pulse time offset O relative to the raw glottal signal h(t) by maximizing the correlation coefficient between the synthetic pulse and the pitch period long portion of the raw glottal source signal starting at time offset O, as follows:

$$[ {Rd}^{*} , {O}^{*} ] = arg {max}_{Rd} [ {max}_{O} \frac{〈 p ( Rd ) , {h}_{O}^{T 0} 〉}{‖ p ( Rd ) ‖ ‖ {h}_{O}^{T 0} ‖} ] \qquad ( A 1 )$$

where:
p(Rd) is the glottal pulse derivative waveform corresponding to Rd, T0 and Ee=1;
h_{O}^{T0}=[h(O), h(O+1), . . . , h(O+T0−1) is the one-pitch-cycle-long portion of the raw glottal source signal h(t) starting at the time offset t=P;
<x,y> designates the scalar product of the vectors x and y;
∥x∥ designates the Euclidean norm of vector x.

The simplex search method described in “Convergence Properties of the Nelder-Mead Simplex Method in Low Dimensions” (J. Lagarias, et al., SIAM Journal of Optimization, Vol. 9 Number 1, pp. 112-147, 1998) may be used to solve the scalar optimization problem in equation A1.

Preliminary glottal pulse fitter 302 further estimates a preliminary gain Q as:

Q= [symbol] p(Rd*),h_{O*}^{T0}) [symbol] /∥p(Rd*)∥² (A2)

Preliminary glottal pulse fitter 302 thus produces values for Rd*, O* and Q.

A noise level estimator 304 is configured to estimate an aspiration noise signal ξ within one pitch cycle, using the output from preliminary glottal pulse fitter 302 and the raw glottal source signal h(t), as follows:

ξ=h_{O*}^{T0}−Q·p(Rd*) (A3)

The aspiration noise signal is high-pass filtered by noise level estimator 304, such as with the cutoff frequency set to 500 Hz, and the aspiration noise level ρ is calculated as:

$$ρ = \frac{‖ \tilde{ξ} ‖}{Q \cdot ‖ p ( {Rd}^{*} ) ‖} \qquad ( A 4 )$$

where \tilde{ξ} is the high-pass filtered aspiration noise signal ξ.

A final glottal pulse fitter 306 is configured to perform pulse shape refinement by optimizing Ta with the fixed Tp* and Te* values corresponding to the optimal Rd* value as follows:

$${Ta}^{*} = arg {min}_{Ta} ‖ log H - 0.5 \cdot log [ {Q}^{2} \cdot P ( {Tp}^{*} , {Te}^{*} , Ta ) + {Q}^{2} \cdot {σ}^{2} \cdot Ξ ] ‖ \qquad ( A 5 )$$

where:
H is the power spectrum derived from a low order, such as 6, all-pole model fitted to the raw glottal source signal;
P is the power spectrum of the LF glottal pulse derivative waveform corresponding to Tp*, Te*, Ta, T0 and Ee=1;
Ξ is the power spectrum of the same high-pass filter applied to the aspiration noise signal determined by noise level estimator 304;
The factor σ is calculated as:

σ=ρ·P̅(̅T̅p̅*̅,̅T̅e̅*̅,̅T̅a̅)̅/Ξ̅ (A6)
where x̅ designates the sum of the components of vector x.

The golden section search method with parabolic interpolation described in “Algorithms for Minimization without Derivatives” (R. Brent, Prentice-Hall, Englewood Cliffs, N.J., 1973) may be used to solve the scalar minimization problem in equation A5.

Final glottal pulse fitter 306 thus produces values for Ta* and a factor σ* using equation A6 with substitution Ta=Ta*.

A smoother 308 is configured to smooth the temporal trajectories of the glottal pulse parameters Tp*, Te*, and Ta*, and of the aspiration noise level ρ, within each sequence of consecutive voiced frames. This is done by using a moving averaging window, such as of 7 frames. References below to Tp*, Te*, Ta*, and ρ refer to their smoothed values.

A vocal tract parameterization unit 310 estimates the glottal source power spectrum in frequency domain as:

Ψ=P(Tp*,Te*,Ta*)+σ*²·Ξ (A7)

and fits to it a low-order, such as 6, all-pole model. This yields the glottal source auto-regression (AR) operator ψ which is then applied to the frame waveform s:

ν=ψ⊗s (A8)

where ⊗ designates the convolution operation.

Vocal tract parameterization unit 310 fits an all-pole model to the output ν of the filtering operation of equation A8, producing the vocal tract AR operator which is converted to an LSF vector. In one embodiment operating at the sampling rate of 22 kHz, the vocal tract all-pole model order is set to 40, and therefore the LSF vector dimension is equal to 40.

A gain estimator 312 is configured to estimate the glottal pulse gain Ee by comparing one-pitch-cycle energy of the frame waveform to one-pitch-cycle energy of a synthetic waveform.

A reference energy is calculated as:

$${W}_{ref} = {\sum }_{t = {O}^{*}}^{{O}^{*} + T 0 - 1} {s ( t )}^{2} \qquad ( A 9 )$$

where s(t) is the frame waveform.

A synthetic energy is calculated as:

$${W}_{syn} = \frac{\overline{Ψ / Ω}}{L} \qquad ( A 10 )$$

where:
Ψ is produced using equation A7;
Ω is the power spectrum of the vocal tract AR operator calculated by vocal tract parameterization unit 310;
L is the Discrete Fourier Transform length; and
x̅ designates the sum of the components of vector x.

Gain estimator 312 calculates the gain as:

$$Ee = \sqrt{\frac{{W}_{ref}}{{W}_{syn}}} \qquad ( A 11 )$$

The following vocoder parameters of each voiced frame are stored in augmented TTS voice dataset 112 (FIG. 1):
normalized glottal pulse shape parameters rTp=Tp*/T0, rTe=Te*/T0, rTa=Ta*/T0, and gain Ee;
the aspiration noise level ρ;
the vocal tract LSF vector;
the pitch frequency F0.

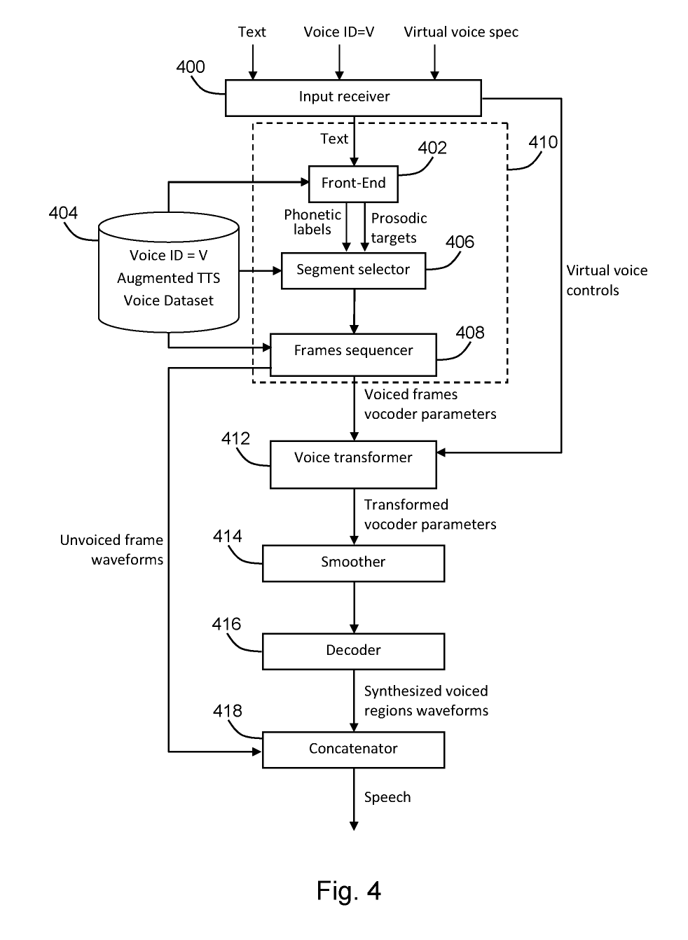

Reference is now made to FIG. 4, which is a simplified block diagram illustration of a system for text-to-speech synthesis, constructed and operative in accordance with an embodiment of the invention. In the system of FIG. 4, an input receiver 400 receives a voice dataset identifier V, an input text to be converted to audio speech, and a virtual voice specification νν. Virtual voice specification νν is a set of voice transformation control parameters, also referred herein as virtual voice controls, denoted as follows:

νν={G,T₁,T₂, . . . ,Tₙ,B} (S1)

where:
G represents glottal tension;
T₁, T₂, . . . Tn represent timbre; and
B represents breathiness.

Each virtual voice control is preferably set within a predefined numeric range, such as within the [−1,1] interval, where a virtual voice control with a zero value indicates that no transformation of a corresponding voice characteristic is to be applied during TTS synthesis. In one embodiment, the virtual voice specification is expressed using a human-readable markup language, such as the Extensible Markup Language (XML). For example, a virtual voice specification may be expressed as:

<virtual-voice glottal_tension=“−0.7” timbre=“{0.4,−0.6,0.3}” breathiness−“−0.2”>This is the text to be synthesized.</virtual-voice>
where:
glottal_tension corresponds to G;
timbre corresponds to T₁, T₂, T₃; and
breathiness corresponds to B.

A front-end unit 402 is configured in accordance with conventional techniques to process the input text and produce a sequence of contextual phonetic labels and prosodic targets associated with the labels using a TTS voice dataset identified by voice dataset identifier V, where the TTS voice dataset is preferably stored in an augmented TTS voice dataset 404, such as is configured in the manner described hereinabove with reference to augmented TTS voice dataset 112 of FIG. 1.

A segment selector 406 is configured in accordance with conventional techniques to process the phonetic labels and prosodic targets and produce a sequence of segment identifiers from the segments in the TTS voice dataset identified by voice dataset identifier V.

A frames sequencer 408 is configured to process the sequence of segment identifiers and, using a segmental frames list stored in augmented TTS voice dataset 404 in association with voice dataset identifier V, produce a sequence of frame identifiers corresponding to the sequence of segments identified by the sequence of segment identifiers.

Front end 402, segment selector 406, and frames sequencer 408 are collectively referred to herein as frame selector 410.

A voice transformer 412 is configured to use the sequence of frame identifiers to identify and retrieve corresponding voiced frames as represented by their vocoder parameters from augmented TTS voice dataset 404 that are associated with voice dataset identifier V. Using the virtual voice controls of equation S1, voice transformer 412 modifies the glottal pulse parameters, vocal tract parameters, and aspiration noise level of each voiced frame as described below.

Glottal Pulse Modification

Voice transformer 412 modifies the glottal pulse parameters of each voiced frame using virtual voice control G. A modified glottal pulse parameters vector Pₒᵤₜ is calculated as:

$$\begin{matrix}{P}_{out} = ( 1 - {G}_{act} ) \cdot {P}_{inp} + {G}_{act} \cdot {P}_{pol} & ( S 2 ) \\ {G}_{act} = \{ \begin{matrix}{γ}_{min} \cdot G , & if - 1 \leq G \leq 0 \\ {γ}_{max} \cdot G , & if 0 < G \leq 1\end{matrix} & ( S 3 )\end{matrix}$$

where:
Pᵢₙₚ and Pₒᵤₜ are the original and modified glottal pulse parameters vectors;
γₘᵢₙ and γₘₐₓ are predefined constants satisfying constraints −1<γₘᵢₙ<0<γₘₐₓ<1, for example γₘᵢₙ=−0.6 and γₘₐₓ=0.7;
Pₚₒₗ is a glottal pulse parameters vector corresponding to one of two predefined polar pulses Pₗₐₓ and Pₜₑₙₛₑ. Pₚₒₗ is selected as follows:

$${P}_{pol} = \{ \begin{matrix}{P}_{lax} , & if - 1 < G \leq 0 \\ {P}_{tense} , & if 0 < G \leq 1\end{matrix} \qquad ( S 4 )$$

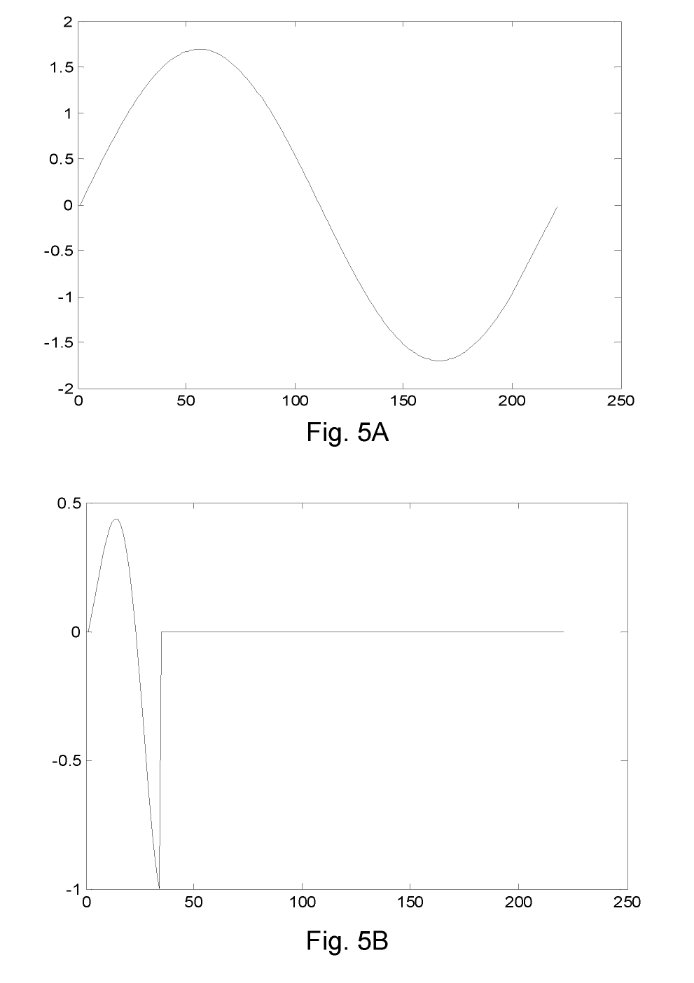

The two polar glottal pulses Pₗₐₓ and Pₜₑₙₛₑ are preferably defined to correspond respectively to a relatively low and a relatively high glottal tension. For example, using the LF glottal pulse model, the following settings may be used:
Pₗₐₓ=[rTp=0.5, rTe=0.9, rTa=0.099]
Pₜₑₙₛₑ=[rTp=0.1, rTe=0.15, rTa=0.00001]
   where Pₗₐₓ is shown in FIG. 5A and Pₜₑₙₛₑ is shown in FIG. 5B.

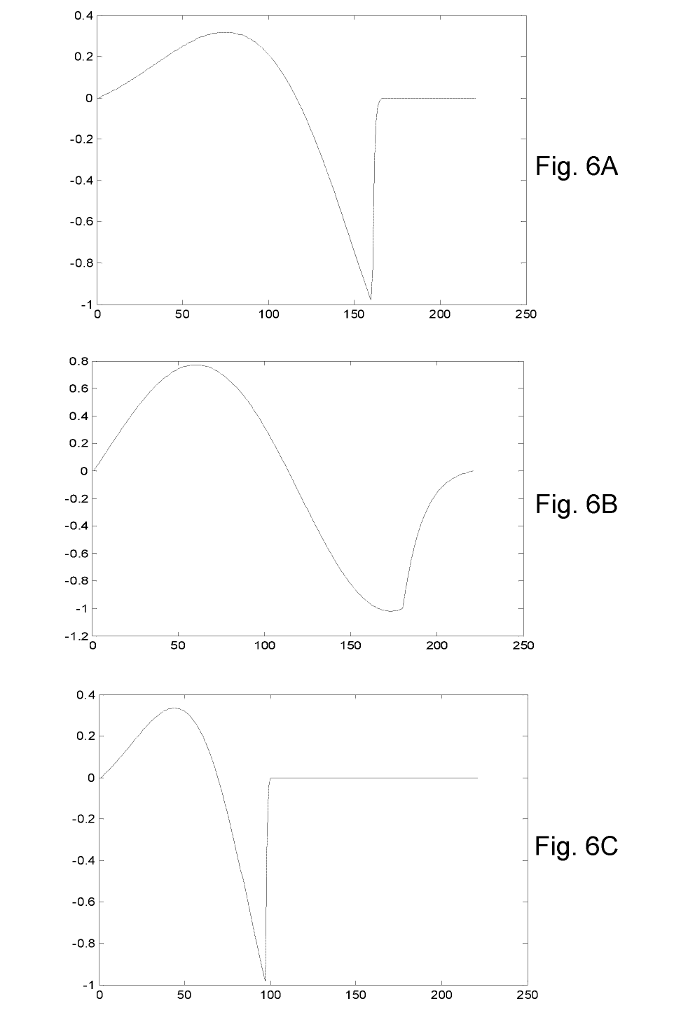

The glottal pulse modification represents a mixing of the original glottal pulse and either the lax or the tense polar glottal pulse depending on the value of virtual voice control G. The mixing proportion depends on the absolute value of G, where a positive G value increases the perceived glottal tension while a negative G value decreases the perceived glottal tension. The predefined constants γₘᵢₙ and γₘₐₓ define limits of the mixing proportion. This is shown by way of example in FIGS. 6A-6C where an original glottal pulse derivative is shown in FIG. 6A, its modification corresponding to a lower glottal tension with G<0 is shown in FIG. 6B, and its modification corresponding to a higher glottal tension with G>0 is shown in FIG. 6C.

Vocal Tract Modification

Voice transformer 412 modifies the vocal tract component of each voiced frame using virtual voice controls {Ti, i=1, . . . , n}. The vocal tract parameters are converted to the vocal tract power spectrum V(f) in accordance with conventional techniques. A modified vocal tract power spectrum V_{mod}(f) is calculated as:

V_{mod}(f)=V(w(f)) (S5)

where w(f) is a monotonous piece-wise linear frequency warping function passing throw N break points as follows:

(yᵢ,xᵢ=w(yᵢ)),i=1, . . . ,N} (S6)

where (N−2) is equal to or greater than the number n of virtual voice controls {Tᵢ}. The break point coordinates xᵢ and yᵢ, referred to as input and output nodes respectively, are set such that:

x₀=y₀=0;xₖ<xₖ₊₁;yₖ<yₖ₊₁;x_{N}=_{N}=Fₛ/2 (S7)

where Fₛ is the sampling frequency. The frequency warping function for any frequency f that falls within an interval [yₖ, yₖ₊₁] is calculated as:

$$w ( f ) = {x}_{k} \frac{{y}_{k + 1} - f}{{y}_{k + 1} - {y}_{k}} + {x}_{k + 1} \frac{f - {y}_{k + 1}}{{y}_{k + 1} - {y}_{k}} \qquad ( S 8 )$$

In various embodiments, all the input nodes are predefined, whereas the output nodes are set depending on the virtual voice controls T₁, T₂, . . . , Tₙ. For example, for synthesizing speech at a sampling rate of Fₛ=22050 Hz, the input and output nodes may be defined as follows:

x₀=y₀=0

x₁=200;y₁= [symbol] (200,100,350,T₁)

x₂=600;y₂= [symbol] (600,400,800,T₂)

x₃=1200;y₃= [symbol] (1200,900,1600,T₃)

x₄=2200;y₄= [symbol] (2200,1900,2600,T₄)

x₅=y₅=4000

x₆=y₆=11025 (S9)

In equation S9 the function [symbol] is defined as:

$$( x , {y}_{min} , {y}_{max} , T ) {=}^{Δ} \{ \begin{matrix}T \cdot {y}_{max} + ( 1 - T ) \cdot x , & if 0 \leq T \leq 1 \\ - T \cdot {y}_{min} + ( 1 + T ) \cdot x , & if - 1 \leq T < 0\end{matrix} \qquad ( S 10 )$$

In the equations above, the output nodes y₁, y₂, y₃, y₄ are interpolated between predefined values according to the vocal tract control parameters T₁, T₂, T₃ and T₄ respectively. Such settings allow for controlling the vocal tract shape in the perceptually important frequency band 0-4000 Hz and thus changing the perceived personality of the synthesized voice.

The modified power spectrum (S5) is converted to modified vocal tract parameters in accordance with conventional techniques. For example, if the LSF representation is used for the vocal tract component, then an all-pole model is fitted to the modified power spectrum yielding an auto-regression operator which is converted to an LSF vector.

To compensate for energy change resulting from the vocal tract modification, the gain parameter Ee of the frame is modified as:

$${Ee}_{mod} = \sqrt{\frac{\overline{V}}{\overline{{V}_{mod}}}} \cdot Ee \qquad ( S 11 )$$

Aspiration Noise Modification

Voice transformer 412 modifies the aspiration noise level of each voiced frame in accordance with virtual voice control B:

$$\begin{matrix}{ρ}_{out} = {B}_{act} \cdot {ρ}_{inp} & ( S 12 ) \\ {B}_{act} = \{ \begin{matrix}B \cdot {B}_{max} + 1 - B \cdot {B}_{max} & if 0 \leq B \leq 1 \\ - B \cdot {B}_{min} + 1 + B \cdot {B}_{min} & if - 1 \leq B < 0\end{matrix} & ( S 13 ) \\ 0 < {B}_{min} < 1 < {B}_{max} & ( S 14 )\end{matrix}$$

where:
ρᵢₙₚ and ρₒᵤₜ are the original and modified aspiration noise level values respectively;
Bₘᵢₙ and Bₘₐₓ are predefined constants that limit the modification. For example, they may be set to Bₘᵢₙ=0.2 and Bₘₐₓ=5.

A smoother 414 is configured to perform smoothing of the temporal trajectories of the transformed vocoder parameters of consecutive voiced frames across non-contiguous segment joints, which are joints between two segments that are not consecutive segments of the same speech signal. This smoothing may be implemented by applying a moving averaging window to the parameter trajectory in a vicinity of the non-contiguous segment joints. For example, the vicinity radius may be set to 5 frames, and the moving averaging window size may be set to 7 frames. Preferably, all of the vocoder parameters of the voiced frames are smoothed in this manner.

A decoder 416 is configured to assemble sequences of consecutive voiced frames, where each voiced frame is represented by its smoothed transformed vocoder parameters. Each such sequence represents a voiced region. Decoder 416 converts each sequence to a speech waveform representing the respective voiced region. Decoder 416 may employ any decoding technique suitable for use with the vocoder parameters described herein. In one embodiment, LSF vocal tract parameters and an LF glottal pulse model are decoded using the method described in “Mixed source model and its adapted vocal-tract filter estimate for voice transformation and synthesis” (G. Degottex, et al, Speech Communication, 2013).

A concatenator 418 is configured to compose a final synthesized speech signal by splicing the synthesized voiced region waveforms produced by decoder 416 together with unvoiced frames from the augmented TTS voice dataset 404, which may be performed in accordance with any conventional splicing technique, thereby producing a digital audio signal of synthesized speech.

Control values for other types of modifications, such as of pitch and speech rate, may be added to the virtual voice specification and applied by decoder 416 in accordance with conventional techniques.

Although embodiments of the invention described herein employ a unit selection text-to-speech synthesis technology also known as concatenative text-to-speech, the invention, with modifications and variations that will be apparent to those of ordinary skill in the art, can be applied to a system employing statistical text-to-speech technology using statistical models, such as Hidden Markov Models (HMM) or Deep Neural Networks (DNN), for vocoder parameter generation.

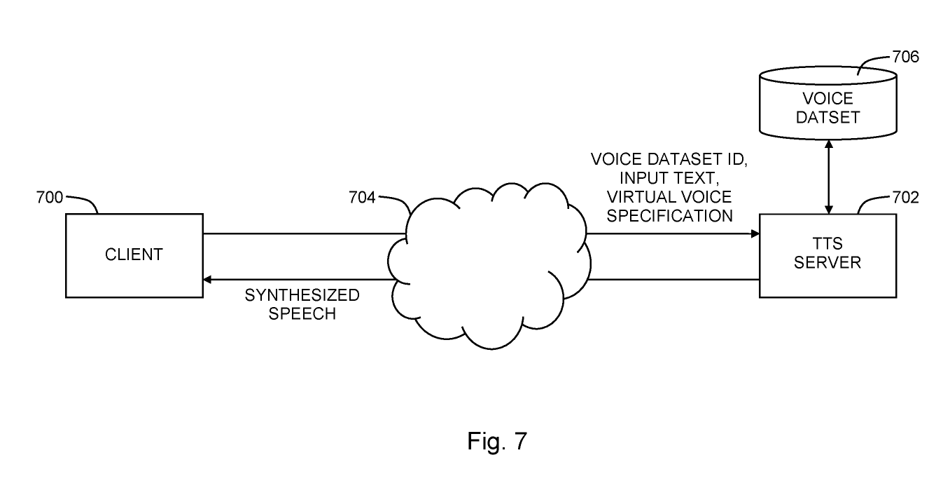

Reference is now made to FIG. 7, which is a simplified block diagram illustration of an end-to-end system for text-to-speech synthesis with dynamically-created virtual voices, constructed and operative in accordance with an embodiment of the invention. A client 700, which may be any computing device, such as, for example, a desktop or mobile computer or a cellular telephone or other mobile computing device, is shown communicating with a TTS server 702 via a communications network 704, such as the Internet. Client 700 provides to TTS server 702 a voice dataset identifier, an input text to be converted to audio speech, and a virtual voice specification, such as are described hereinabove with reference to FIG. 4. TTS server 702 uses the voice dataset identifier to identify and accesses a voice dataset 706, such as where voice dataset 706 is prepared in the manner described hereinabove with reference to augmented TTS voice dataset 112 of FIG. 1. TTS server 702 then converts the input text into synthesized audio speech in the manner described hereinabove with reference to FIG. 4 and provides the synthesized speech to client 700.

Any of the elements shown in the drawings and described herein are preferably implemented by one or more computers in computer hardware and/or in computer software embodied in a non-transitory, computer-readable medium in accordance with conventional techniques.

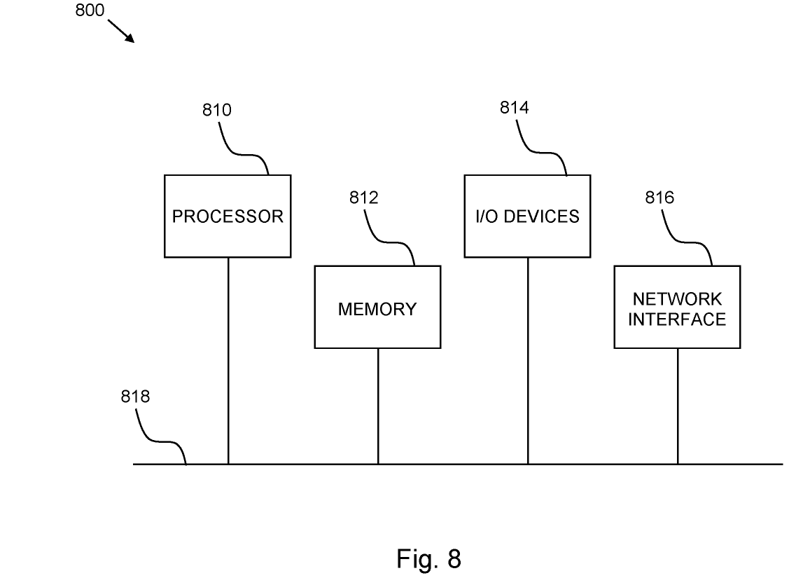

Referring now to FIG. 8, block diagram 800 illustrates an exemplary hardware implementation of a computing system in accordance with which one or more components/methodologies of the invention (e.g., components/methodologies described in the context of FIGS. 1-7) may be implemented, according to an embodiment of the invention. As shown, the invention may be implemented in accordance with a processor 810, a memory 812, I/O devices 814, and a network interface 816, coupled via a computer bus 818 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A text-to-speech synthesis method comprising:
deriving from a voice dataset a sequence of speech frames corresponding to a text, wherein any of the speech frames is represented in the voice dataset by a parameterized vocal tract component, glottal pulse parameters, and an aspiration noise level;
transforming the speech frames in the sequence by applying a voice transformation to any of the parameterized vocal tract component, glottal pulse parameters, and aspiration noise level representing the speech frames, wherein the voice transformation is applied in accordance with a virtual voice specification that includes at least one voice control parameter indicating a value for at least one of timbre, glottal tension and breathiness; and
producing a digital audio signal of synthesized audible speech from the transformed sequence of speech frames.

2. The method according to claim 1 and further comprising:
receiving the text, a voice identifier identifying the voice dataset, and the virtual voice specification, and
performing the deriving, transforming, and producing responsive to receiving the text, voice identifier, and virtual voice specification.

3. The method according to claim 2
wherein the receiving comprises receiving at a server computer,
wherein the text, a voice identifier identifying the voice dataset, and the virtual voice specification are sent by a client computing device, and
wherein the server computer is configured to perform the deriving, transforming, and producing, and provide the synthesized speech to the client computing device.

4. The method according to claim 1 and further comprising smoothing the transformed sequence of speech frames by replacing any element in any selected speech frame in the transformed sequence of speech frames with a weighted average of the element in speech frames in the transformed sequence of speech frames that precede and follow the selected speech frame.

5. The method according to claim 1 wherein the parameterized vocal tract component is represented by Line Spectral Frequency vector components.

6. The method according to claim 1 wherein the transforming comprises applying the voice transformation to the parameterized vocal tract component by modifying the vocal tract spectrum using frequency warping.

7. The method according to claim 1 wherein the glottal pulse parameters include Liljencrants-Fant glottal pulse model parameters.

8. The method according to claim 7 wherein the Liljencrants-Fant glottal pulse model parameters are calculated by
estimating a raw glottal signal,
fitting a preliminary glottal pulse by determining the Rd-value that maximizes a time-domain fit criterion,
estimating aspiration noise, and
refining the glottal pulse by determining a Ta-value that minimizes the log-spectrum difference between the raw glottal source signal and a synthetic glottal source signal generated from the glottal pulse and the aspiration noise estimate.

9. The method according to claim 1 wherein the transforming comprises applying the voice transformation to the glottal pulse parameters using a convex linear combination of the original glottal pulse parameters vector and a predefined glottal pulse parameters vector.

10. The method according to claim 1 wherein the deriving, transforming, and producing are implemented in any of
a) computer hardware, and
b) computer software embodied in a non-transitory, computer-readable medium.

11. A text-to-speech synthesis system comprising:
a frame selector configured to derive from a voice dataset a sequence of speech frames corresponding to a text, wherein any of the speech frames is represented in the voice dataset by a parameterized vocal tract component, glottal pulse parameters, and an aspiration noise level;
a voice transformer configured to transform the speech frames in the sequence by applying a voice transformation to any of the parameterized vocal tract component, glottal pulse parameters, and aspiration noise level representing the speech frames, wherein the voice transformation is applied in accordance with a virtual voice specification that includes at least one voice control parameter indicating a value for at least one of timbre, glottal tension and breathiness; and
a concatenator configured to produce a digital audio signal of synthesized audible speech from the transformed sequence of speech frames.

12. The system according to claim 11 and further comprising an input receiver configured to receiving the text, a voice identifier identifying the voice dataset, and the virtual voice specification.

13. The system according to claim 12
wherein the input receiver, frame selector, voice transformer, and concatenator are embodied in a server computer,
wherein the text, a voice identifier identifying the voice dataset, and the virtual voice specification are sent by a client computing device, and
wherein the server computer is configured to provide the synthesized speech to the client computing device.

14. The system according to claim 11 and further comprising a smoother configured to smooth the transformed sequence of speech frames by replacing any element in any selected speech frame in the transformed sequence of speech frames with a weighted average of the element in speech frames in the transformed sequence of speech frames that precede and follow the selected speech frame.

15. The system according to claim 11 wherein the parameterized vocal tract component is represented by Line Spectral Frequency vector components.

16. The system according to claim 11 wherein the voice transformer is configured to apply the voice transformation to the parameterized vocal tract component by modifying the vocal tract spectrum using frequency warping.

17. The system according to claim 11 wherein the glottal pulse parameters include Liljencrants-Fant glottal pulse model parameters.

18. The system according to claim 17 wherein the Liljencrants-Fant glottal pulse model parameters are calculated by
estimating a raw glottal signal,
fitting a preliminary glottal pulse by determining the Rd-value that maximizes a time-domain fit criterion,
estimating aspiration noise, and
refining the glottal pulse by determining a Ta-value that minimizes the log-spectrum difference between the raw glottal source signal and a synthetic glottal source signal generated from the glottal pulse and the aspiration noise estimate.

19. The system according to claim 11 wherein the voice transformer is configured to apply the voice transformation to the glottal pulse parameters using a convex linear combination of the original glottal pulse parameters vector and a predefined glottal pulse parameters vector.

20. A computer program product for text-to-speech synthesis, the computer program product comprising:
a non-transitory, computer-readable storage medium; and
computer-readable program code embodied in the storage medium, wherein the computer-readable program code is configured to
derive from a voice dataset a sequence of speech frames corresponding to a text, wherein each of the speech frames is represented in the voice dataset by a parameterized vocal tract component, glottal pulse parameters, and an aspiration noise level,
transform the speech frames in the sequence by applying a voice transformation to any of the parameterized vocal tract component, glottal pulse parameters, and aspiration noise level representing the speech frames, wherein the voice transformation is applied in accordance with a virtual voice specification that includes at least one voice control parameter indicating a value for at least one of timbre, glottal tension and breathiness, and
producing a digital audio signal of synthesized audible speech from the transformed sequence of speech frames.
